(19) United States
(12) Patent Application Publication
(10) Pub. No.: US 2014/0014423 A1
(43) Pub. Date: Jan. 16, 2014

(54) HYBRID DRIVE DEVICE FOR MOTOR VEHICLES

(71) Applicants: Emil DIMITROV, Plovdiv (BG); Nikolai GANEV, Plovdiv (BG)

(72) Inventors: Emil DIMITROV, Plovdiv (BG); Nikolai GANEV, Plovdiv (BG)

(73) Assignee: Emil Manolov Dimitrov, Plovdiv (BG)

(21) Appl. No.: 14/025,784

(22) Filed: Sep. 12, 2013

Related U.S. Application Data
(63) Continuation-in-part of application No. 13/060,048, filed on Feb. 21, 2011, now Pat. No. 8,534,401.

(30) Foreign Application Priority Data
Aug. 21, 2008 (BG) BG 1487

(51) Int. Cl. B60K 6/00

(52) U.S. Cl. CPC B60K 6/00; Y10S 903/951
USPC 180/65.22; 903/951

(57) ABSTRACT

The present invention relates to hybrid drive for vehicles that significantly decreases the consumption of fuel because it uses a turbine motor, which is turned on solely when the charge of the accumulator batteries drops and always works at best rpm. The device increases the distance covered by the vehicle without need for frequent recharge of the batteries from the power supply network. Furthermore, the turbine motor is lighter than the petrol piston engine and in the same time more efficient. The device includes installed accumulator batteries that supply power to at least one electric motor coupled via transmission to the drive wheels of the vehicle, and fuel tank supplying fuel to turbine motor coupled via reducer to generator that is connected to the accumulator batteries. Control unit monitors the charge of the accumulator batteries and turns on and off the turbine motor. Some embodiments include one or more containers for compressed gas that replaces batteries as means of storage of energy, by storing the energy generated by the compressor actuated by the turbine engine or the electric motor in the form of high pressurized gas.

### CROSS-REFERENCE TO RELATED APPLICATION

This application is a continuation-in-part of U.S. application Ser. No. 13/060,048, filed Feb. 21, 2011.

### TECHNICAL FIELD OF THE INVENTION

The present invention relates to a hybrid drive device for motor vehicles and finds application in the automobile industry.

### BACKGROUND OF THE INVENTION

Automobiles known as Series Hybrid are vehicles driven by an electric motor wherein another motor, e.g. combustion engine, is used solely to recharge the accumulator batteries. Known is an electric automobile driven by electric motor in which the batteries are used to store electric energy from the power supply network or another external source. The electric motor uses this stored energy to drive the automobile until the energy is exhausted.

Known from publication U82007114078 is a vehicle including a petrol engine that drives a generator, which generates electric current and charges the batteries which on their side power the electric motor that drives the automobile. This embodiment with a petrol engine can only use liquid fuel, e.g. petrol, to produce electric energy which results in the automobile engine being heavier but with lower power and lower efficiency. The petrol piston engine works in synchronously with the electric motor, which increases the fuel consumption and decreases the distance that the vehicle can cover.

A pneumatic motor is a mechanism that takes compressed air and converts it into energy that is then used for mechanical work U.S. Pat. No. 6,862,973. Also known is Quasiturbine Pneumatic turbines, known to be used to generate electric power U.S. Publication No. 20040079321 A1.

### SUMMARY OF THE INVENTION

The goal of this invention is to create a hybrid drive for vehicles that increases the distance covered by the vehicle without the need for frequent recharge of the batteries from the power supply network and at the same time decreases the fuel consumption in view of lowering the noxious emissions.

The goal is achieved by a hybrid drive for vehicles including batteries mounted on the chassis of the vehicle, which supply power to at least one electric motor. The electric motor is coupled by the means of a transmission to the drive wheels of the vehicle.

According to the present invention, the chassis supports a fuel tank to supply fuel to a turbine engine. Via a reducer, the turbine engine is coupled to a generator that produces electric energy and is connected to the batteries to recharge them. On the chassis shall be installed a control unit that controls the level of charge of the accumulator batteries and commands the switching on or off of the turbine engine.

In one embodiment of the present invention, the fuel tank contains liquid fuel. Another embodiment is possible wherein the tank contains compressed combustible gas.

In yet another embodiment of the present invention, when the tank contains compressed combustible gas, it is possible to install between the tank and the turbine engine a pneumatic turbine connected to the power generator. There is an embodiment in which the pneumatic turbine is coupled to an additional power generator.

In the case when the tank contains compressed non-combustible gas, the hybrid drive of the vehicle includes accumulator batteries installed on the chassis of the vehicle, which supply power to at least one electric motor. Via a transmission, the electric motor is coupled to the drive wheels of the vehicle. Through a duct from the tank, compressed non-combustible gas is supplied to a pneumatic turbine, which is coupled via a reducer to a power generator which generates electric energy and recharges the accumulator batteries.

It is possible to be installed an electric motor that is coupled to a compressor unit that allows a quick recharge of the tank for compressed non-combustible gas or compressed air.

The chassis shall support a control unit that controls the level of charge of the accumulator batteries. It is possible to couple one electric motor to each of the two front drive wheels. Another embodiment of the present invention provides for one electric motor coupled to each one of the four wheels of the vehicle. All embodiments of the present invention provide for a device to recharge the accumulator batteries from the power supply network.

The advantage of the present invention consists in that it significantly decreases the fuel consumption because a turbine motor is used that is only activated when the charge of the accumulator batteries is low, and it always works at optimum mode. Thus, the distance covered by the vehicle is increased without need to frequently recharge the batteries from the power supply network because they are recharged by the action of the turbine motor. Furthermore, the turbine motor is lighter than the petrol piston engine and in the same time more efficient.

### DESCRIPTION OF THE DRAWINGS

The present invention is explained through the embodiment shown on the enclosed figures, wherein:

FIG. 1 shows a line diagram of the hybrid drive of a vehicle with electric motors coupled to the two drive wheels and using liquid fuel;

FIG. 2 shows an embodiment of the device with electric motors coupled to the four wheels of the vehicle and using liquid fuel;

FIG. 3 shows an embodiment of the device using compressed combustible gas;

FIG. 4 shows an embodiment of the device in which a pneumatic turbine is installed between the compressed combustible gas tank and the turbine motor;

FIG. 5 shows an embodiment of the device shown on FIG. 4, in which the pneumatic turbine is connected to an additional power generator;

FIG. 6 shows an embodiment of the device without turbine motor but only with pneumatic turbine;

FIG. 7 shows an embodiment of the device including pneumatic turbine, turbine engine and four electric motors;

FIG. 8 shows an embodiment of the device as shown in FIG. 7 including two power generators;

FIG. 9 shows an embodiment of the device including pneumatic turbine and single driving electric motor for the front axle;

FIG. 10 shows an embodiment of the device same as FIG. 9 including built-in electric motor in each wheel;

FIG. 11 shows another embodiment of the device including turbine engine connected to compressor similar connected to high pressure tanks which store energy for pneumatic turbine;

FIG. 12 shows another embodiment of the device same as FIG. 11 including electric pump connected to high pressure tanks which store energy for pneumatic turbine;

FIG. 13 shows an embodiment of the device same as FIG. 11 where one electric motor is incorporated in each of the four wheels of the vehicle;

FIG. 14 shows an embodiment of the device same as FIG. 12 where one electric motor is incorporated in each of the four wheels of the vehicle.

### DETAILED DESCRIPTION OF THE INVENTION

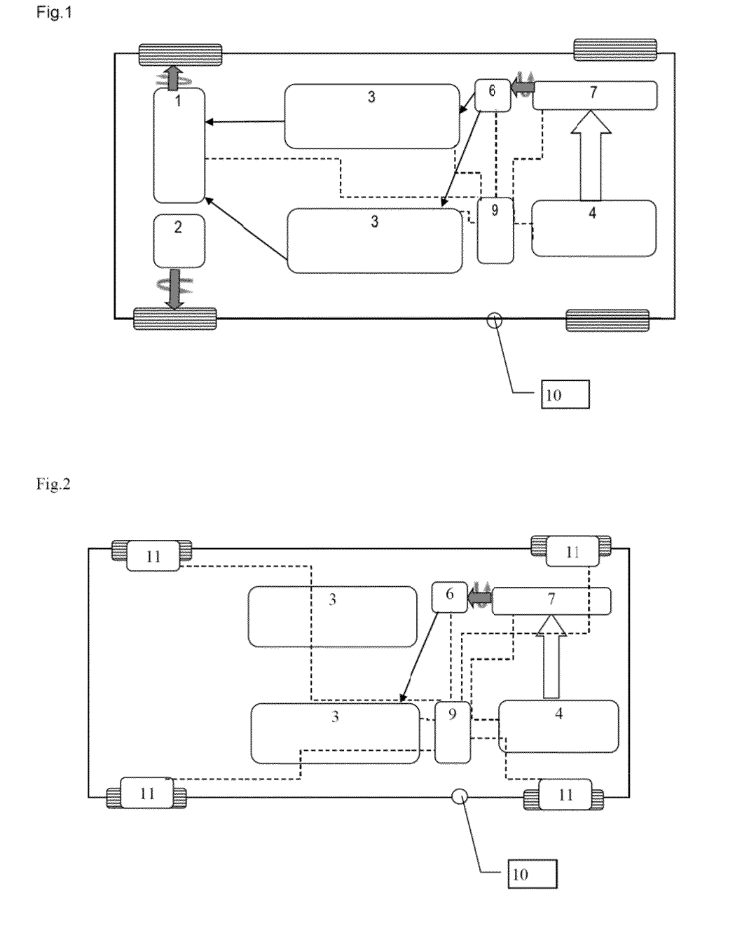

As shown in FIG. 1, the hybrid drive of a vehicle comprises accumulator batteries (3) installed on the chassis that supply power to an electric motor (1), which is connected via the transmission (2) to the two drive wheels of the vehicle. A liquid fuel tank (4) that supplies power to the turbine motor (7) is installed on the chassis. The torque of the turbine motor (7) is transmitted to power generator (6). The power generator (6) produces electric current to recharge the accumulator batteries (3).

The device is also fitted with control unit (9) that controls the charge of the accumulator batteries (3). When the charge of the accumulator batteries (3) drops below a certain level, the control unit (9) starts the turbine motor (7). When the accumulator batteries are completely recharged, the control unit (9) sends a signal to turn off the turbine motor (7). In all embodiments of the device an arrangement (10) is fitted for recharge of the accumulator batteries from the power supply network. Arrangement (10) permits the driver to manually charge the accumulator batteries (3). Liquid fuel tank (4) is connected to turbine motor (7) with a white arrow, representing a fuel line. Turbine motor (7) is connected to power generator (6) with a dark grey arrow with a circular arrow around it—representing torque. Power generator (6) is connected to accumulator batteries (3) with thin black arrows representing electric power. Similarly, accumulator batteries (3) are connected to electric motor (1) with thin black arrows, again representing electric power. Electric motor (1) is connected to transmission (2) with a dark grey arrow with a half circular arrow around it representing torque.

FIG. 2 illustrates another embodiment of the device in which an electric motor (11) is incorporated in each of the four wheels of the vehicle. As one of ordinary skill in the art would appreciate, FIG. 2 does not require a transmission.

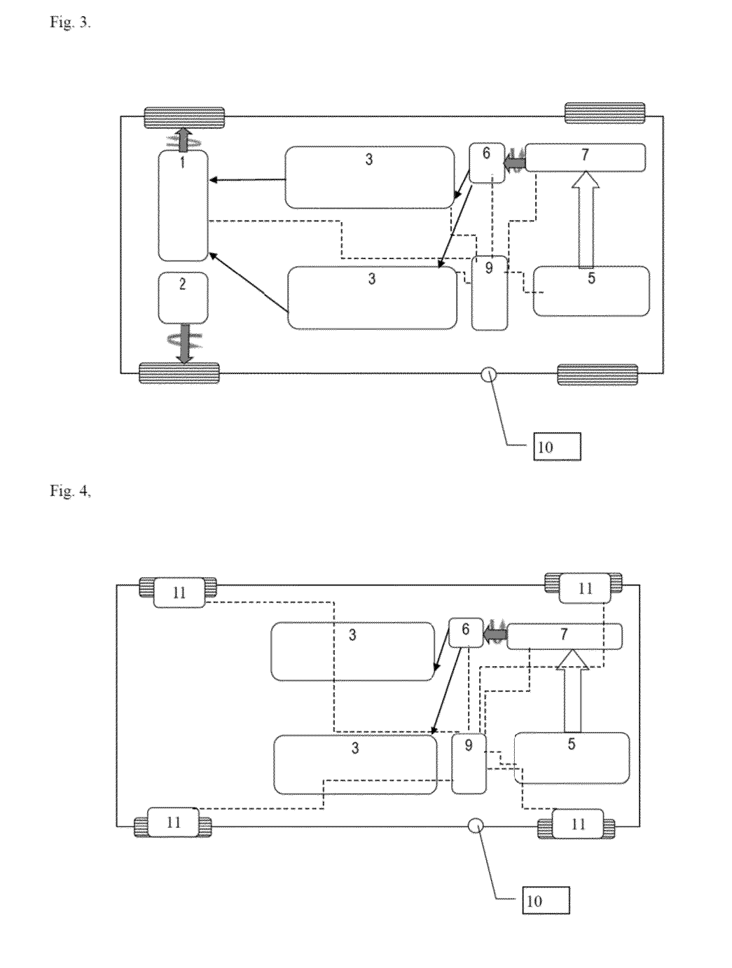

FIG. 3 illustrates an embodiment of the device similar to FIG. 1 except that tank (5) contains compressed combustible gas instead of liquid fuel.

In the embodiment of the device disclosed in FIG. 4, is the same as FIG. 2 except that liquid fuel tank (4) has been replaced with compressed combustible gas tank (5).

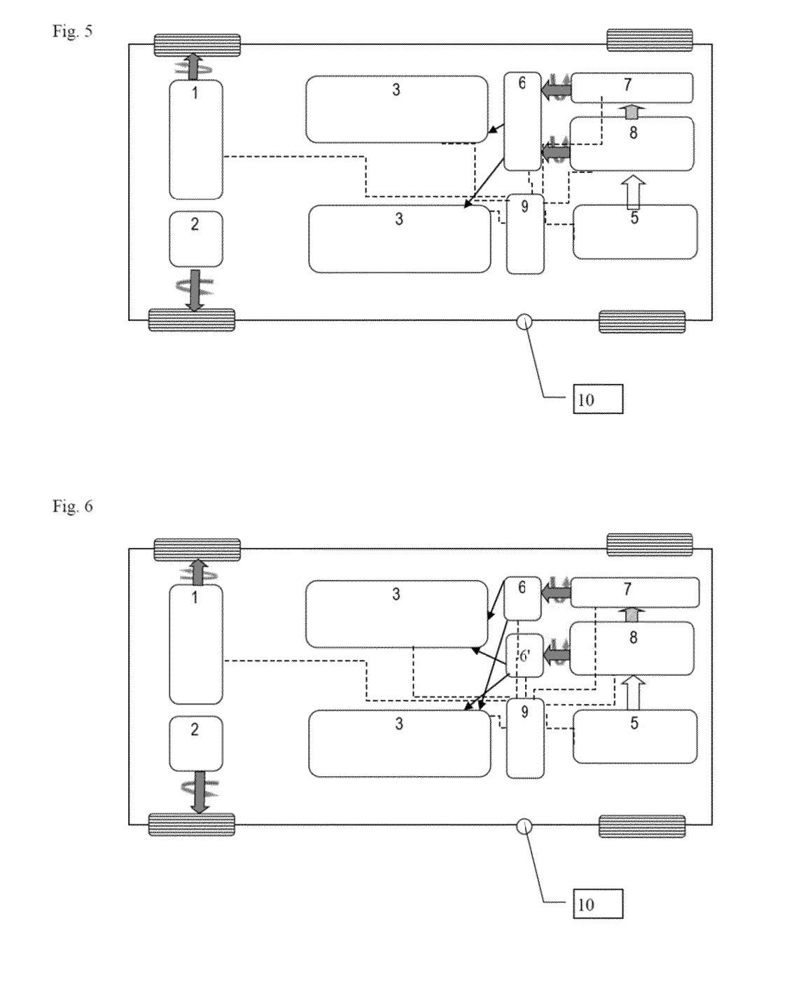

FIG. 5 is similar to FIG. 3 except that pneumatic turbine (8) has been added between the tank (5) and the turbine motor (7). Along a gas duct, the compressed combustible gas is fed from the tank (5) to the pneumatic turbine (8). In the pneumatic turbine (8), the compressed combustible gas expands, the pressure drops and the turbine (8) is actuated. The combustible gas, at pressure lowered in the pneumatic turbine (8), is fed into the turbine motor where it burns. The torques resulting from the work of the pneumatic turbine (8) and the turbine motor (7) are transmitted through to the power generator (6). In this way, the power generator (6) produces electric current and recharges the accumulator batteries (3).

The device of FIG. 5 is further fitted with control unit (9) that controls the charge of the accumulator batteries (3). When the charge of the accumulator batteries (3) drops, the control unit (9) sends a signal to start the turbine motor (7). When the accumulator batteries (3) are fully recharged, the control unit (9) sends a signal to turn off the turbine motor (7). Pneumatic turbine (8) is connected to turbine motor (7) with a lightly shaded arrow representing decompressed gas.

FIG. 6 illustrates an embodiment in which the torque from the pneumatic turbine (8) is transmitted to additional generator (6′).

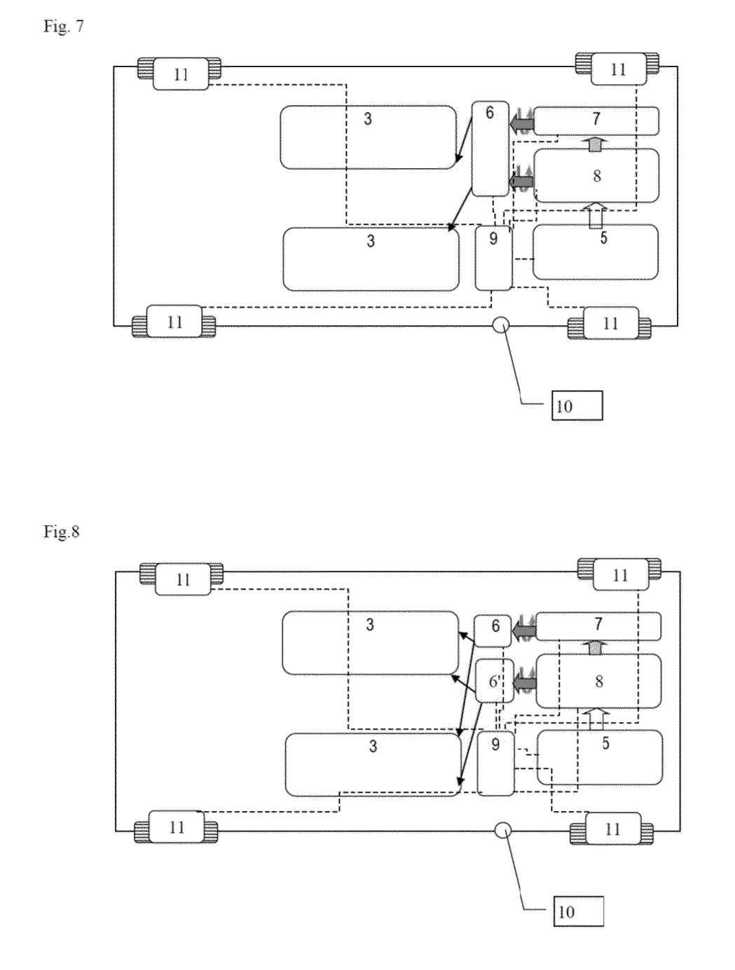

As shown in FIG. 7 to the chassis in the front or rear of the vehicle is mounted turbine engine (7) CNG, LPG, gas or other fuel stored under high pressure in a tank of compressed gas (5) to the turbine (Turbo-shaft) engine (7) is connected via motor/reduction gear or a power generator (6).

When using CNG, LPG, gas or other fuel stored under high pressure in a tank of compressed gas (5) is used together with pneumatic turbine (8) and turbine (Turbo-shaft) engine (7) by the compressed gas passes through pneumatic turbine (8) and drives it and then the fuel gas (5) is used in a turbine (Turbo-shaft) engine (7) for fuel which drives it. Starting and stopping of a turbine engine is controlled by an electronic unit (9) depending on the level of charge the battery (3).

Upon starting the vehicle electrical control unit (9) checks the status of the battery and if necessary starts turbine (Turbo-shaft) engine (7) and/or pneumatic turbine (8) if low. Batteries (3) have enough electric power car began work as a standard electric car.

Generated electricity is stored in storage batteries (3), which provides electricity to power an electric motor incorporated in the wheels (11) which operates independently on all four wheels of the vehicle. To increase fuel economy the arrangement (10) can be used by the driver to charge the batteries(3) from the power grid. During braking and deceleration of the vehicle energy/momentum by the electronic control unit (9) electric motor (11) produce energy which is returned to the batteries (3).

On FIG. 8 is shown embodiment of the device same as FIG. 7 with the difference that there is separate power generator (6) and power generator (6′) for the pneumatic turbine (8) and the turbine (Turbo-shaft) engine (7).

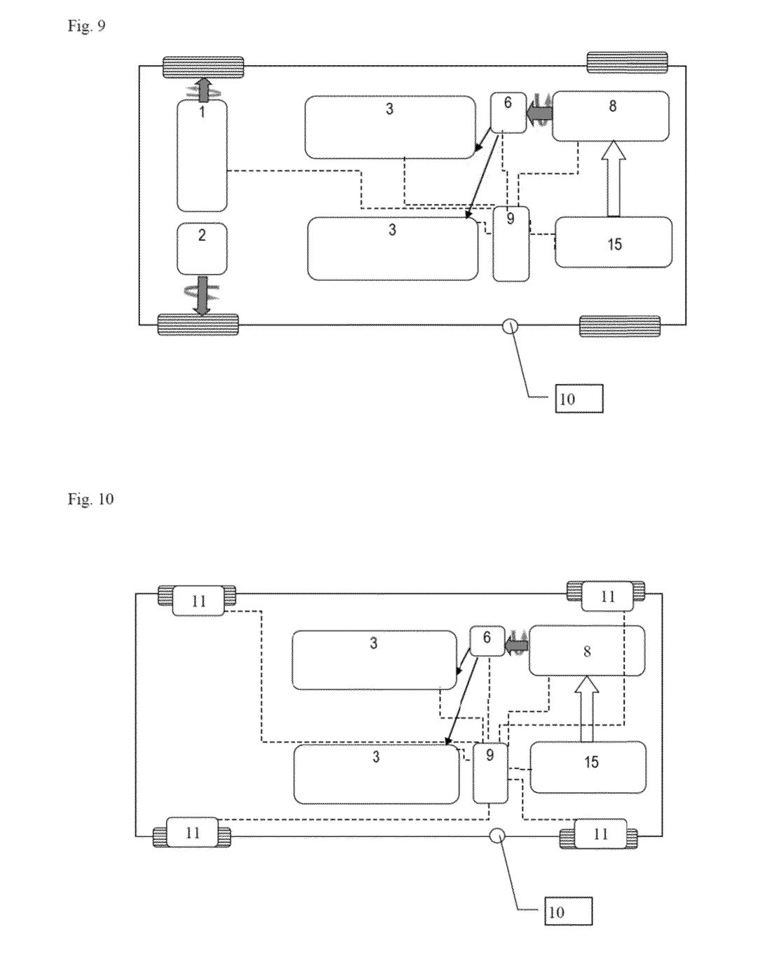

As shown in FIG. 9 to the chassis in the front or rear of the vehicle is mounted pneumatic turbine (8) Compressed air or other Nonflammable gas stored under high pressure in a tank of compressed gas (15) to the pneumatic turbine (8) is connected with a generator (6) pneumatic turbine (8) drives the generator (6). Starting and stopping the pneumatic turbine (8) is controlled by the electronic control unit (9) depending on the charge level of the battery (3).

Upon starting the vehicle electrical control unit (9) checks the status of the battery (3) and if necessary starts pneumatic turbine (8). If the batteries (3) have enough electricity the car operates as a standard electric car. One of ordinary skill in the art would appreciate that high pressure noncombustible gas tank (15) could be replaced with compressed combustible gas tank (5).

FIG. 10 shows an embodiment of the device same as FIG. 9 where instead of motor (1) and transmission (2), there is electric motor (11) incorporated in each wheel.

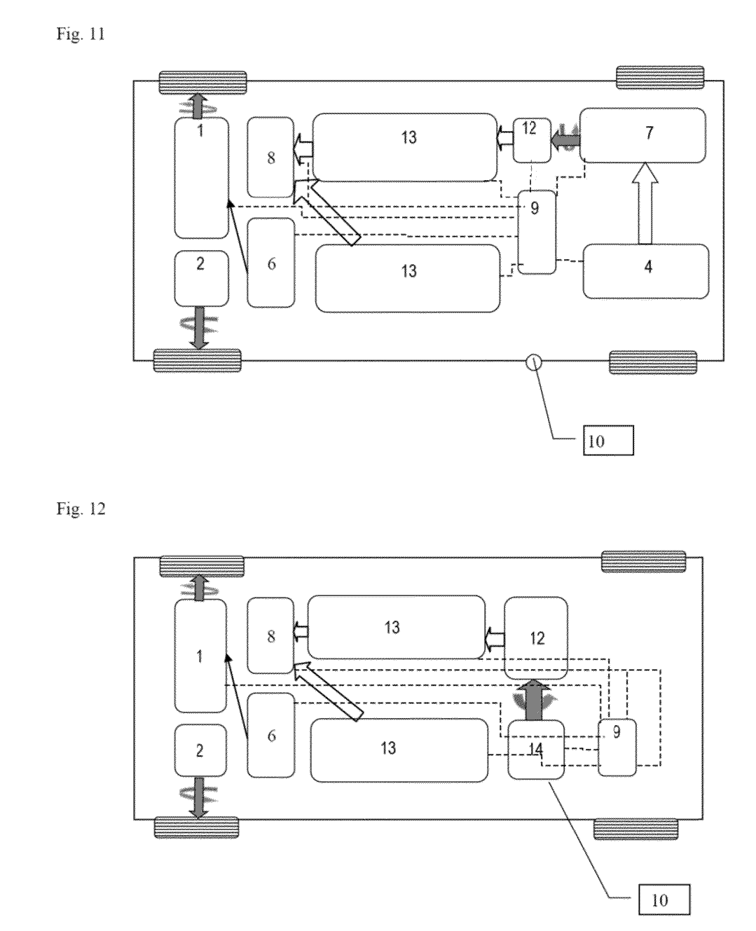

In FIG. 11 is shown an embodiment of the device where to the chassis in the front or rear of the vehicle is mounted turbine engine (7) powered by liquid fuel tank (4) which drives the air compressor (12) which blows air into containers for compressed gas (13). Electronic unit 9 controls the starting and stopping of Turbo-shaft (turbine) engine (7) depending on pressure vessels for compressed gas (13). Compressed gas from the vessel (13), drives the pneumatic turbine (8) which is connected to a generator (6) producing the electrical energy, which drives the motor (1), which through transmission (2) drives the vehicle. The electrical control unit (9) regulates the start and stop of the Turbine engine (7) depending the pressure level in vessels for compressed gas (13) and controls the work of the pneumatic turbine (8)

On in FIG. 12 is shown embodiment of the device where to the chassis in the front or rear of the vehicle is mounted electric motor (14) powered by power plug device which drives the air compressor (12) which blows air into containers for compressed gas (13). Compressed gas from the vessel (13), drives the pneumatic turbine (8) which is connected to a generator (6) producing the electrical energy, which drives the motor (1), which through transmission (2) drives the vehicle. The electrical control unit (9) regulates the start and stop of the pneumatic turbine (8). Also, depending on the pressure level in vessels for compressed gas (13), the electrical control unit (9) regulates the work of the electric motor (14).

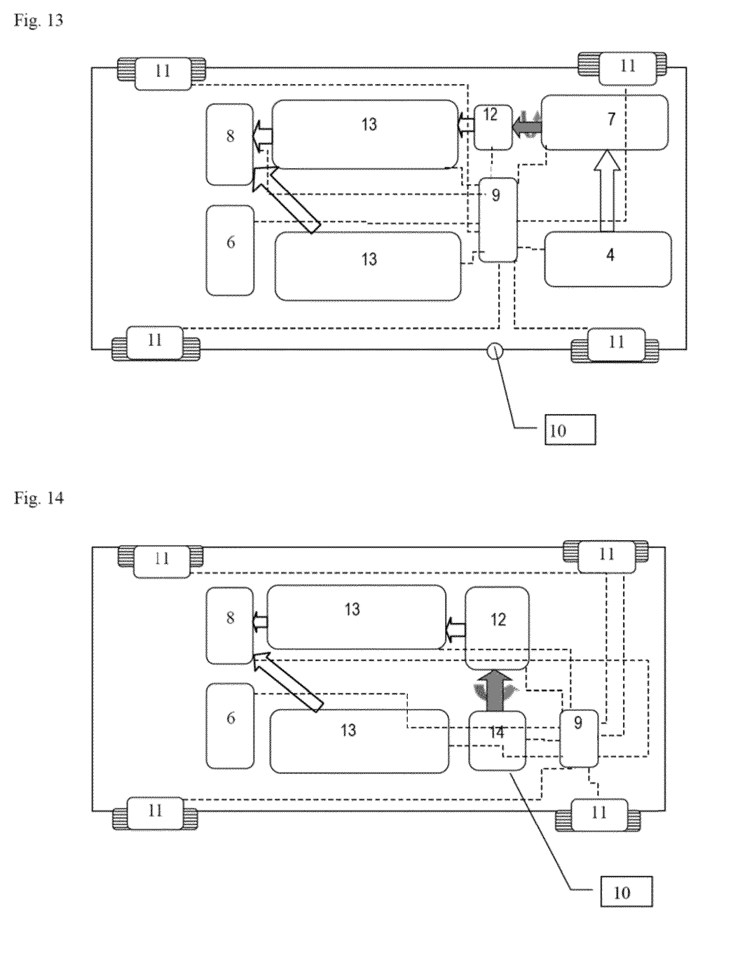

On FIG. 13 is shown embodiment of the device same as FIG. 11 where one electric motor (11) is incorporated in each of the four wheels of the vehicle. The device of FIG. 14 is embodiment of the device same as FIG. 12 where one electric motor (11) is incorporated in each of the four wheels of the vehicle.

1. Hybrid drive for vehicles comprising installed on the chassis of the vehicle accumulator batteries (3) that supply power to at least one electric motor (1) connected via transmission (2) to the drive wheels of the vehicle, including a liquid fuel tank (4) that supplies fuel to turbine motor (7) wherein the turbine motor (7) is connected to generator (6), which is connected to the accumulator batteries (3); further including a control unit (9) that monitors the charge of the accumulator batteries (3) and controls the turbine motor (7).

2. Hybrid drive for vehicles as claimed in claim 1, further including one electric motor (11) that is connected to each of the four wheels of the vehicle.

3. Hybrid drive for vehicles as claimed in claim 1, further including an arrangement (10) installed to charge the accumulator batteries (3) from the power supply network.

4. Hybrid drive for vehicles comprising accumulator batteries (3) that supply power to at least one electric motor (1) connected via transmission (2) to the drive wheels of the vehicle, further including a compressed non-combustible gas tank (15) connected through a duct to pneumatic turbine (8) coupled to generator (6), which is connected to the accumulator batteries (3) and where control unit (9) monitors the charge of the accumulator batteries (3).

5. Hybrid drive for vehicles as claimed in claim 4, further including an electric motor (11) is connected to each of the four wheels of the vehicle.

6. Hybrid drive for vehicles as claimed in claim 4 further including a device (10) configured to charge the accumulator batteries (3) from the power supply network.

7. Hybrid drive for vehicles comprising installed on the chassis of the vehicle comprising turbine engine (7), fuel tank (4) that supplies fuel to turbine engine (7), which drives the air compressor (12) that supplies compressed noncombustible gas through a gas duct to containers for compressed gas (13) that supply pressure to at least one pneumatic turbine (8) connected to a generator (6) producing the electrical energy, which drives the motor (1), which through transmission (2) drives the vehicle.

8. Hybrid drive for vehicles as claimed in claim 7, further including a device (10) connected to the electric motor (14) wherein the electric motor (14) actuates the air compressor (12).

9. Hybrid drive for vehicles as claimed in claim 7, further including one electric motor (11) connected to all four wheels of the vehicle.

10. Hybrid drive for vehicles as claimed in claim 7, further including four electric motors (11), where each of said four electric motors (11) is connected to one of the four wheels of the vehicle.
